(19) United States
(12) Patent Application Publication
(10) Pub. No.: US 2003/0142010 A1
(43) Pub. Date: Jul. 31, 2003

(54) Radar apparatus

(75) Inventor: Masaru Ogawa, Seto-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOYOTA CHUO KENKYUSHO, Aichi-gun (JP)

(21) Appl. No.: 10/342,354

(22) Filed: Jan. 15, 2003

(30) Foreign Application Priority Data
Jan. 30, 2002 (JP) 2002-022502

(51) Int. Cl. G01S 13/34

(52) U.S. Cl. 342/118; 342/128; 342/129

(57) ABSTRACT

A radar apparatus in which a VCO sequentially outputs while switching a signal of a first frequency f1 and a signal of a second frequency f2 at a predetermined timing, a transmitting antenna radiates the signal, a receiving antenna receives a reflected wave obtained from the radiated signal being reflected off a measuring object, a beat signal as a difference in frequency between the signal that is currently being radiated by the transmitting antenna and the received reflected wave is detected at a mixer and a bandpass filter, and the distance to the measuring object is measured from the beat signal.

### BACKGROUND OF THE INVENTION

a) Field of the Invention

The present invention relates to a radar apparatus, such as for use in measuring the distance to a proximate object, and more particularly to improving measurement accuracy and reducing manufacturing cost.

b) Description of the Related Arts

Radar apparatuses for measuring the distance to an object in proximity to a vehicle are being developed as in-vehicle radar systems. Heretofore, this sort of radar apparatus often employed the so-called pulse system. Namely, a pulse signal of a predetermined frequency is radiated, the reflected wave of the pulse signal reflecting off the object is received, the propagation delay time between the pulse signal and the reflected wave is measured, and the distance to the object is determined on the basis of the propagation delay time.

However, the above-mentioned radar apparatus exhibited the following problem. Namely, in the case of an in-vehicle radar apparatus, for example, it is common to narrow the pulse width of the transmitted pulses in order to resolve a plurality of objects located in the vehicle's periphery. However, when the transmitted pulses are narrowed, the peak power of the transmitted pulses is limited. A drop in peak power leads to a drop in the effective transmitted power, thereby resulting in a deterioration in the accuracy of detecting objects. A radar apparatus is disclosed in Japanese Patent Laid-Open Publication No. 2001-42029 as a method for solving this problem. In this conventional radar apparatus, the transmitted pulse width is set longer than the time from when a transmitted pulse reaches the farthest positioned object until when the reflected wave is received. The transmitted pulse and the reflected wave are converted into DC signals by waveform shaping. These two DC signals are multiplied, and the distance to the object is measured on the basis of a result comparing the multiplication result and the transmitted pulse. However, this method requires a waveform shaping circuit for high-frequency signals, and as the frequency increases in the microwave and millimeter wave bands used for radar, the resulting problems were the difficulty in procuring high-performance waveform shaping circuits and their high cost.

### SUMMARY OF INVENTION

In view of the foregoing, it is therefore an object of the present invention to provide a radar apparatus capable of accurately measuring the distance to a relatively proximate object while lowering the manufacturing cost.

The present invention for solving the aforementioned conventional problems in a radar apparatus comprises a signal generator for sequentially outputting while switching at a predetermined timing at least a signal of a first frequency and a signal of a second frequency, a radiation device for radiating the signal, and a detector for receiving a reflected wave obtained from the radiated signal reflecting off a measuring object and detecting a beat signal as a difference in frequency between the signal currently being output by the signal generator and the received reflected wave. The radar apparatus measures the distance to the measuring object from the detected beat signal.

The detector mentioned here may detect, average power or cumulative power of the beat signal, and supplies the average power or the cumulative power to a calculation of the distance to the measuring object, or the detector may detect a time in which the beat signal is detected, and supplies the time to a calculation of the distance to the measuring object. Furthermore, a limiting circuit may also be included for limiting a time for detection of the beat signal in the detector. It is preferable for the limiting circuit to limit the time for detection of the beat signal in the detector by disconnecting at a predetermined timing at least either the signal generated by the signal generator or the received reflected wave.

Furthermore, it is also preferable for the signal generator to output a long distance signal in which the frequency is changed for a period longer than the predetermined timing period, and the detector to measure, while the signal generator outputs the long distance signal, at least the distance to the measuring object based on the received reflected wave and the long distance signal that is output by the signal generator. The long distance signal in this case may be an FM-CW system signal having two phases for increasing or decreasing a frequency.

Furthermore, the present invention for solving the aforementioned conventional problems in a distance measurement method comprises sequentially outputting while switching at a predetermined timing at least a signal of a first frequency and a signal of a second frequency, radiating the signal, receiving a reflected wave obtained from the radiated signal reflecting off a measuring object, detecting a beat signal as a difference in frequency between the signal currently being output and the received reflected wave, and measuring the distance to the measuring object from the detected beat signal.

### BRIEF DESCRIPTION OF THE DRAWINGS

FIG. 1 is a block diagram of the radar apparatus relating to a first embodiment of the present invention.

FIG. 2 is a timing chart showing an output signal of a control voltage generator.

FIG. 3 are timing charts showing various signals of the radar apparatus relating to the first embodiment of the present invention.

FIG. 4 is a block diagram of the radar apparatus relating to a second embodiment of the present invention.

FIG. 5 are timing charts showing various signals of the radar apparatus relating to the second embodiment of the present invention.

FIG. 6 is a block diagram of the radar apparatus relating to a third embodiment of the present invention.

FIG. 7 is a timing chart showing a signal that the control voltage generator outputs in the long distance monitor mode.

### DETAILED DESCRIPTION OF THE PREFERRED EMBODIMENTS

Preferred embodiments of the present invention will be described hereinafter with reference to the attached drawings.

Embodiment 1

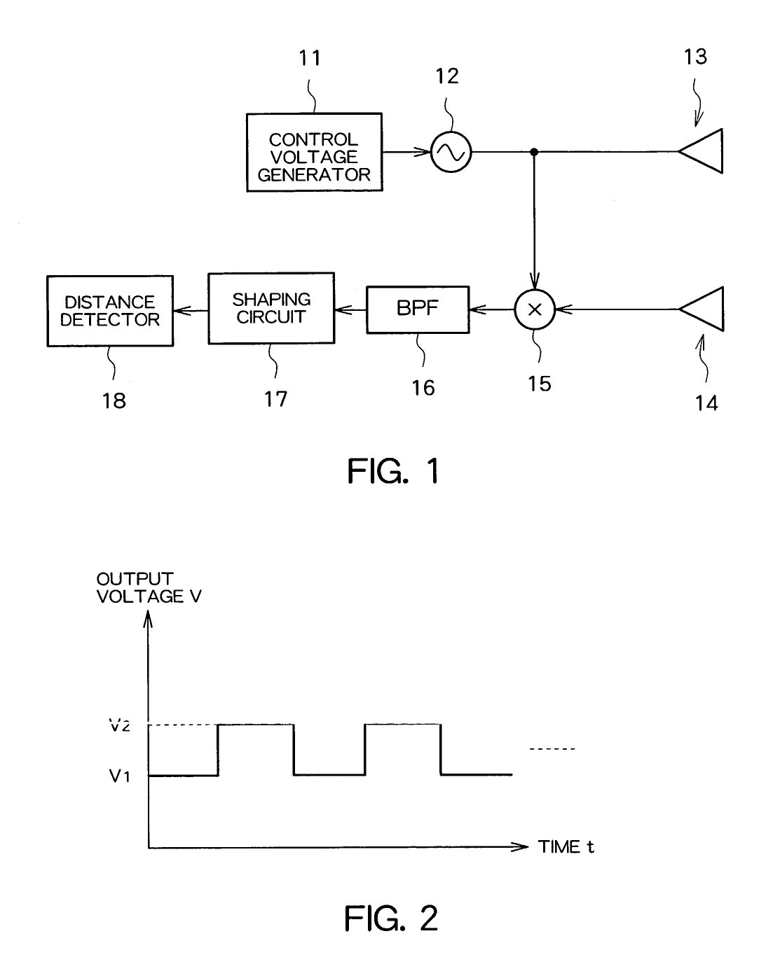

As shown in FIG. 1, the radar apparatus relating to the first embodiment of the present invention comprises a control voltage generator 11, a VCO 12, a transmitting antenna 13, a receiving antenna 14, a mixer 15, a bandpass filter (BPF) 16, a shaping circuit 17, and a distance detector 18.

The control voltage generator 11 outputs a control voltage to the VCO 12. The frequency of the signal that is output by the VCO 12 is controlled by the control voltage that is output by the control voltage generator 11. More specifically, the control voltage generator 11 alternately and periodically outputs a voltage signal of voltage V1 and a voltage signal of voltage V2. Therefore, the voltage signal that is output by the control voltage generator 11 is a pulse-shaped signal as shown in FIG. 2. The VCO 12 outputs to the transmitting antenna 13 and to the mixer 15 a signal having a frequency corresponding to the voltage signal that is output by the control voltage generator 11. The transmitting antenna 13 radiates the signal that is output by the VCO 12.

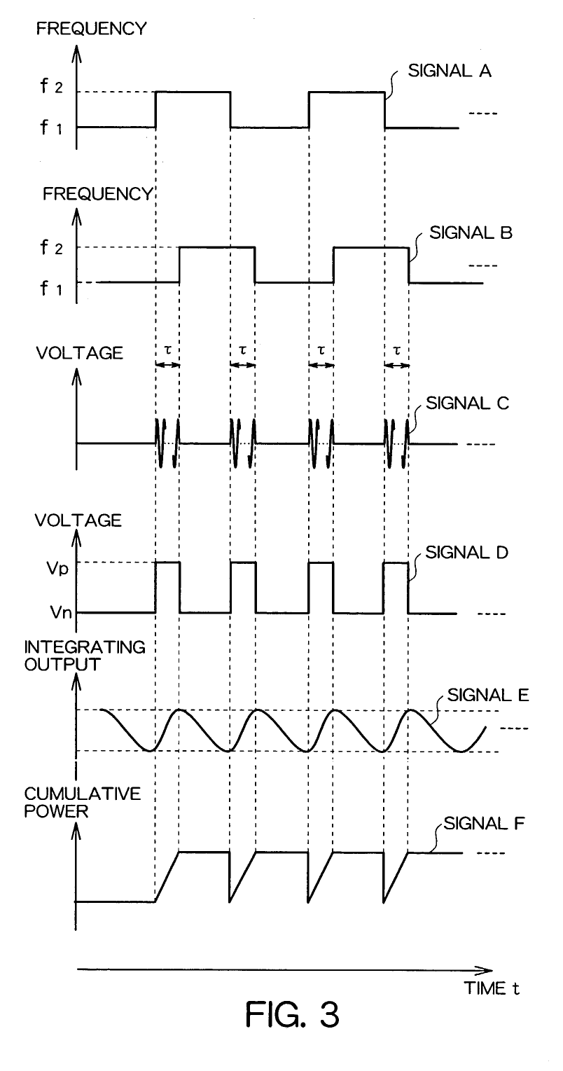

The control voltage generator 11 and the VCO 12 realize the signal generator of the present invention, and the signal that is radiated by the transmitting antenna 13 alternately repeats between frequency f1 corresponding to voltage V1 and frequency f2 corresponding to voltage V2 as shown in signal A of FIG. 3. This signal is reflected by the measuring object and reaches the receiving antenna 14 as a reflected wave.

The receiving antenna 14 receives the incoming reflected wave and outputs it to the mixer 15. Since the signal radiated by the transmitting antenna 13 is received with a delay amounting to the path length up to the measuring object by the receiving antenna 14, as shown in signal B of FIG. 3, the signal that is output by the receiving antenna 14 is slightly delayed with respect to the signal A of FIG. 3. The mixer 15 accepts from the receiving antenna 14 an input of the reflected wave and from the VCO 12 an input of a signal currently being output by the VCO 12, mixes them, and outputs a mixed signal. The BPF 16 corresponds to a detector in the present invention and extracts only a signal of a predetermined frequency band from the signal mixed at the mixer 15 and outputs it as an output signal. It is preferable to set the predetermined frequency band so as to center on the frequency of the difference between f2 and f1. Furthermore, the width of the frequency band should be set according to the application. For example, in the case of an in-vehicle system, since the measuring object can be considered to be a vehicle, the width of the frequency band should be set while taking into account the Doppler effect due to the relative speed between vehicles.

The signal that is output by the BPF 16 is a beat that is generated between the signal currently being output by the VCO 12 and the signal (reflected wave) currently being received by the receiving antenna 14, the frequency of the beat is equal to the absolute value of f2-f1 if the signal currently being output by the VCO 12 and the reflected wave are different, and zero “0” if they are the same. Namely, during the time of a pulse width, the signal that is output by the BPF 16 has a frequency equal to the absolute value of frequency f2-f1 only during delay time τ of the reflected wave, and is a DC signal during the remainder of the period as shown in signal C of FIG. 3.

The shaping circuit 17 outputs a voltage signal of a predetermined voltage Vp while the signal that is input from the BPF 16 has an AC component greater than or equal to a predetermined amount, and a voltage signal of a voltage Vn (such as 0 V) at other times (signal D of FIG. 3). The shaping circuit 17 outputs a binary-coded voltage signal according to the existence or nonexistence of AC component independent of the strength of the signal that is output by the BPF 16 so that measurements of high accuracy are possible even in the case where the signal strength weakens.

The distance detector 18 measures an amount relating to the delay time τ from the signal that is input from the shaping circuit 17 and based on this calculates the distance to the measuring object. More specifically, the distance detector 18 obtains an average power by integrating the signal that is input from the shaping circuit 17 over the time of a pulse width, and outputs the average power as an amount relating to the distance. For example, the result of integration by an RC integrating circuit is shown in signal E of FIG. 3. Furthermore, the cumulative power shown in signal F of FIG. 3 may be used. In this case, it is preferable to reset the result of integration at either the leading edge or trailing edge of the control voltage that is output by the control voltage generator 11.

Furthermore, the distance detector 18 may be designed to more directly detect the timing of the leading edge and the trailing edge of the voltage signal that is output by the shaping circuit 17, detect the delay time τ from their time difference, and output τ as an amount relating to the distance. This can easily be configured from a timer circuit and a circuit for detecting edges of pulse signals.

Therefore, according to the present embodiment, the BPF 16, the shaping circuit 17, and the distance detector 18 following the mixer 15 need only process low frequency signals, such as the beat signal, and can be configured at low cost.

Although the frequencies f1 and f2, which are output by the VCO 12, can be set as desired, it is preferable to set the difference between f1 and f2 sufficiently larger than the amount of Doppler shift to reduce the influence of the Doppler effect due to the relative speed with the measuring object.

Embodiment 2

The radar apparatus relating to the first embodiment is adequate if there is only one proximate object to be measured, such as a vehicle. However, if there are several vehicles, the incoming reflected wave from each vehicle may cause the measurement accuracy to degrade. Accordingly, it is also preferable to improve the measurement accuracy of the distance to the most proximate vehicle by limiting the time for distance detection, defining the maximum measurable distance, and preventing the use for distance detection of any reflected wave from an object farther than the maximum distance.

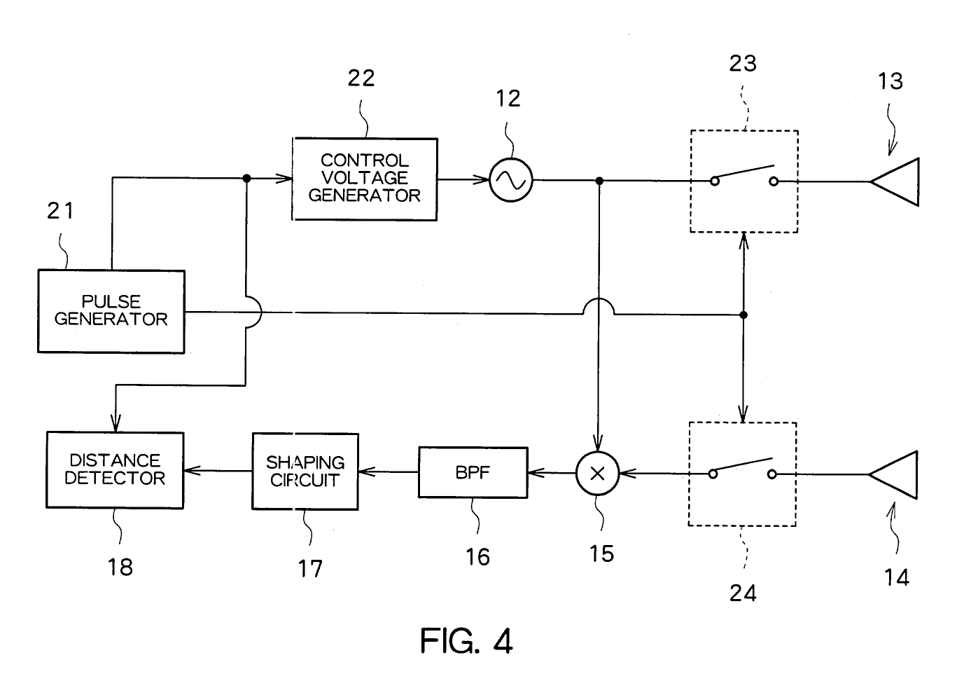

More specifically, as shown in FIG. 4, the radar apparatus according to the second embodiment of the present invention comprises a pulse generator 21, a control voltage generator 22, the VCO 12, a first switch 23, the transmitting antenna 13, the receiving antenna 14, a second switch 24, the mixer 15, the BPF 16, the shaping circuit 17, and the distance detector 18. The components that correspond to those relating to the first embodiment are given the same reference numerals and their detailed descriptions are omitted.

The pulse generator 21 outputs a pulse signal that is “H” only during a time determined in relation with the maximum measurable distance. The control voltage generator 22 is substantially similar to the control voltage generator 11 in the first embodiment although it differs in that the output voltage of the voltage signal is varied between voltage V1 and voltage V2 while the pulse signal that is output by the pulse generator 21 is “H”. It is also preferable to vary the voltage at a timing in the center of the width where the pulse signal that is output by the pulse generator 21 is “H”.

The first switch 23 controls whether or not to output the signal, which is output by the VCO 12, to the transmitting antenna 13. More specifically, the first switch 23 accepts an input of the pulse signal that is output by the pulse generator 21 and turns on while the pulse signal is “H” so that the signal that is output by the VCO 12 is transferred to the transmitting antenna 13. Similarly, the second switch 24 accepts an input of the pulse signal that is output by the pulse generator 21 and turns on while the pulse signal is “H” so that the reflected wave that is received by the receiving antenna 14 is transferred to the mixer 15.

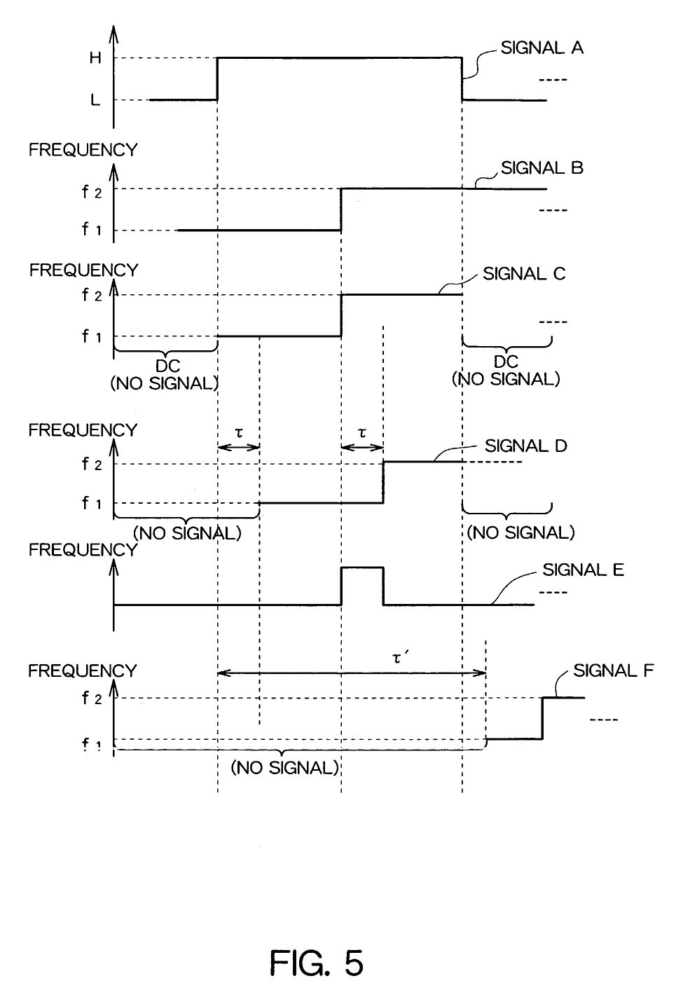

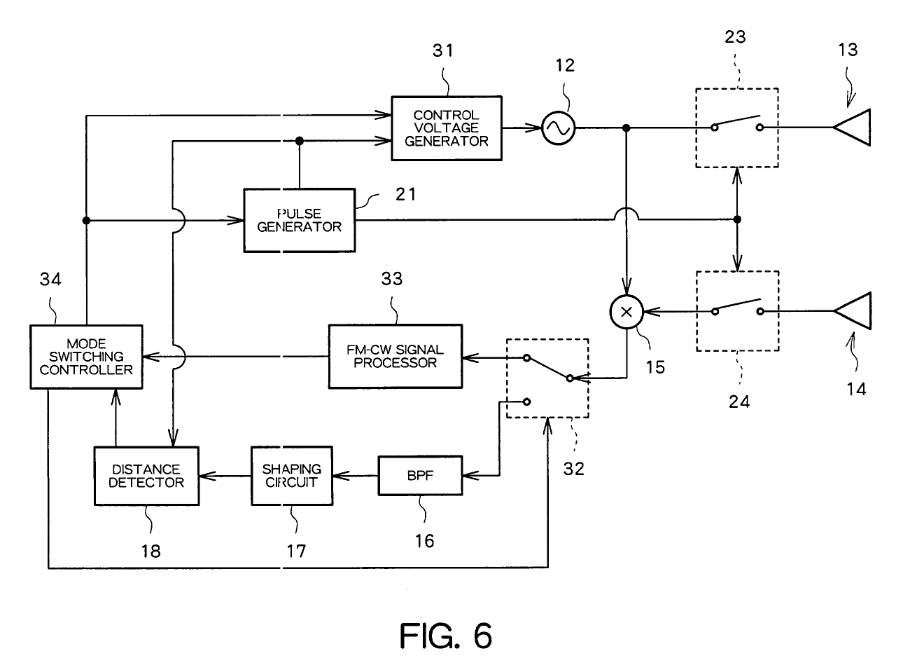

According to the present embodiment, while the pulse signal that is being output by the pulse generator 21 is in a state of “H”(signal A of FIG. 5), the voltage of the voltage signal that is output by the control voltage generator 22 varies, and the frequency of the signal that is output by the VCO 12 varies accordingly (signal B of FIG. 5). Since the signal that is output by the VCO 12 is transmitted via the first switch 23 only while the pulse signal that is being output by the pulse generator 21 is in a state of “H”, the signal that is actually transmitted is shown in signal C of FIG. 5.

The signal C of FIG. 5 is reflected by the measuring object and reaches the receiving antenna 14 as a reflected wave. The signal of the reflected wave that is received by the receiving antenna 14 is received at the period shown in signal D of FIG. 5. The frequency of the reflected wave changes precisely by a delay of the delay time τ dependent on the distance to the measuring object from a change in the frequency of the signal B of FIG. 5. Thus, after mixing at the mixer 15, only the signal component near the frequency of the beat is extracted by the BPF 16, and the shaping circuit 17 outputs a predetermined voltage signal only while the beat is generated so that the signal E of FIG. 5 is output to the distance detector 18.

On the basis of this output signal, the distance detector 18 outputs a signal in relation to the distance to the measuring object. Furthermore, the distance detector 18 does not perform distance detection if there is no output from the shaping circuit 17 during a predetermined time immediately after the output voltage of the control voltage generator 22 changes due to the pulse signal that is output by the pulse generator 21. As a result, the reflected wave off a vehicle located farther from the most proximate vehicle (measuring object) arrives after being further delayed so that the receiving antenna 14 receives the signal of the reflected wave after a delay time of precisely τ′ as shown, for example, in signal F of FIG. 5. At this time, the received signal is not transferred to the mixer 15 due to the operation of the second switch 24 so that the reflected wave off the farther vehicle does not influence the result of the distance detection.

Although the first switch 23 and the second switch 24 are controlled so as to turn on and off at the same timing, the second switch 24 may be controlled so as to turn on when (immediately before) the frequency of the signal that is output by the VCO 12 changes and not the signal that is output by the pulse generator 21.

Furthermore, although the first switch 23 is provided between the VCO 12 and the transmitting antenna 13, the first switch 23 may instead be provided before the output of the VCO 12 is distributed to the mixer 15. In this case, while the first switch 23 is turned off, the output of the VCO 12 is not transferred to the mixer 15 so that even if the received reflected wave is output to the mixer 15, the output of the BPF 16, namely, the output of the shaping circuit 17, is the same as when the beat is not generated. Therefore, the second switch 24 is not always necessary in this case.

Embodiment 3

Furthermore, it is preferable to combine a long distance monitoring radar with the radar apparatus relating to the first and second embodiments to extend the range of the measurement distance. The radar apparatus relating to the third embodiment of the present invention adds a long distance monitor mode to a proximity mode and comprises the pulse generator 21, a control voltage generator 31, the VCO 12, the first switch 23, the transmitting antenna 13, the receiving antenna 14, the second switch 24, a third switch 32, the BPF 16, the shaping circuit 17, the distance detector 18, an FM-CW signal processor 33, and a mode switching controller 34. The components that correspond to those relating to the first and second embodiments are given the same reference numerals and their detailed descriptions are omitted.

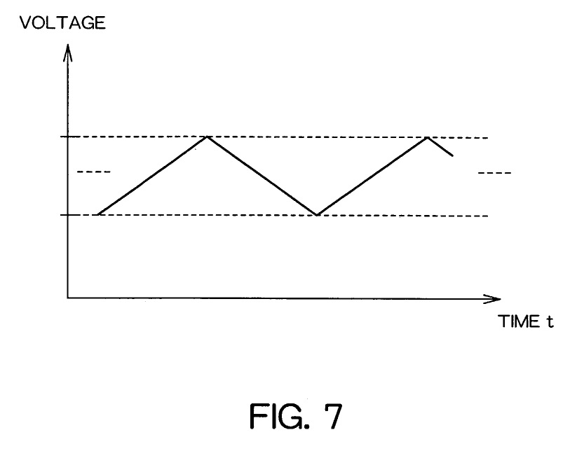

The control voltage generator 31 of the present embodiment accepts an input of a signal (mode select signal) for selecting either the proximity mode or the long distance monitor mode, and performs the same operation as the control voltage generator 22 in the second embodiment when the proximity mode has been selected. If the long distance monitor mode has been selected, the control voltage generator 31 continuously increases or decreases a voltage to output a triangular wave voltage signal as shown in FIG. 7. In this case, the VCO 12 outputs, in accordance with this triangular wave voltage signal, a signal having two phases for increasing or decreasing frequency as an FM-CW signal. In the present embodiment, the pulse generator 21 also accepts an input of the select signal, and outputs a constant “H” signal when the long distance monitor mode has been selected.

The third switch 32 accepts an input of the select signal and outputs to the BPF 16 the signal that is output by the mixer 15 when the proximity mode has been selected. Furthermore, when the long distance monitor mode has been selected, the signal that is output by the mixer 15 is output to the FM-CW signal processor 33.

The FM-CW signal processor 33 detects and outputs the distance to a measuring object or the speed of the measuring object using a well known type of FM-CW radar processing (such as the processing disclosed in “FM-CW Radar Device” of Japanese Laid-Open Patent Publication No. 2001-91639).

The mode switching controller 34 accepts an input of information on the distance to the measuring object from the distance detector 18 or the FM-CW signal processor 33, and based on this, outputs the select signal for selecting either the proximity mode or the long distance monitor mode. More specifically, the mode switching controller 34 initializes (powers up) in the long distance monitor mode, and outputs the select signal for selecting the proximity mode when the distance to the measuring object is less than a predetermined value based on the distance to the measuring object that is periodically input from the FM-CW signal processor 33. Furthermore, in the proximity mode, the select signal for selecting the long distance monitor mode is output if the measuring object cannot be found. Moreover, when considering the case where another vehicle cuts immediately in front of one's own vehicle while traveling on a highway, it is also preferable in the long distance monitor mode to periodically output the select signal for selecting the proximity mode even though the distance to the measuring object is not smaller than a predetermined value so that the distance to the other vehicle (measuring object) can be accurately measured if the other vehicle has entered proximity.

In this case, it is preferable to shorten the period of the distance detection in the proximity mode to less than the period of the distance detection in the long distance monitor mode. This makes it possible to accurately detect the change in position of a proximate measuring object. Furthermore, in the long distance monitor mode, it is preferable to measure the change in the relative speed with the measuring object. It becomes possible to more accurately perform detection, such as of the relative position with the measuring object, based on this information on the change in relative speed and the information relating to the position in the proximity mode.

Shared Receiving Antenna and Transmitting Antenna

In the descriptions of the first, second, and third embodiments, the transmitting antenna 13 and the receiving antenna 14 are provided separately. However, if a circulator is used, one antenna may be used as the transmitting antenna 13 and also as the receiving antenna 14.

Using Three or More Frequencies

Furthermore, in the previous descriptions of the embodiments (of the proximity mode for the third embodiment), the VCO 12 outputs while switching the two frequencies of f1 and f2. However, three or more frequencies, such as f1, f2, f3, . . . , may also be used while being sequentially switched. In this case also, the frequency differs precisely by an amount of delay time up to when the reflected wave is received, and the distance to the measuring object can be measured by the same configuration given above.

According to the present invention, at least the first frequency and the second frequency are sequentially output while being switched at a predetermined timing, the signal is radiated, the reflected wave that is obtained from the radiated signal being reflected off the measuring object is received, and the distance to the measuring object is measured from a beat signal as a difference in frequency between the signal that is currently transmitting and the received reflected wave. Namely, since the beat signal is used, high-frequency processing becomes unnecessary, thereby making it possible to reduce the cost of components and configuration.

Furthermore, by limiting the time used for distance measurement, the signal is processed only from the most proximate measuring object so that the influence of a reflected wave from another measuring object can be reduced and the measurement accuracy can be improved.

While there has been described what are at present considered to be preferred embodiments of the invention, it will be understood that various modifications may be made thereto, and it is intended that the appended claims cover all such modifications as fall within the true spirit and scope of the invention.

What is claimed is:

1. A radar apparatus comprising:
a signal generator for sequentially outputting while switching at a predetermined timing at least a signal of a first frequency and a signal of a second frequency;
a radiation device for radiating said signal; and
a detector for receiving a reflected wave obtained from the radiated signal reflecting off a measuring object and for detecting a beat signal as a difference in frequency between the signal currently being output by said signal generator and the received reflected wave;
the radar apparatus for measuring the distance to the measuring object from the detected beat signal.

2. A radar apparatus according to claim 1, wherein said detector detects, average power or cumulative power of the beat signal, and supplies the average power or the cumulative power to a calculation of the distance to the measuring object.

3. A radar apparatus according to claim 1, wherein said detector detects a time during which the beat signal is detected, and supplies the time to a calculation of the distance to the measuring object.

4. A radar apparatus according to claim 1, wherein the radar apparatus further comprises a limiting circuit for limiting a time for detection of the beat signal difference in said detector.

5. A radar apparatus according to claim 4, wherein said limiting circuit limits the time for detection of the beat signal in said detector by disconnecting at a predetermined timing at least either the signal generated by said signal generator or said received reflected wave.

6. A radar apparatus according to claim 1, wherein said signal generator outputs a long distance signal in which the frequency is changed for a period longer than the predetermined timing period, and
said detector measures, while said signal generator outputs the long distance signal, at least the distance to the measuring object based on the received reflected wave and the long distance signal that is output by said signal generator.

7. A radar apparatus according to claim 6, wherein said long distance signal is an FM-CW system signal having two phases for increasing or decreasing a frequency.

8. A distance measurement method which comprises:
sequentially outputting while switching at a predetermined timing at least a signal of a first frequency and a signal of a second frequency;
radiating said signal;
receiving a reflected wave obtained from the radiated signal reflecting off a measuring object;
detecting a beat signal as a difference in frequency between the signal currently being output and the received reflected wave; and
measuring the distance to the measuring object from the detected beat signal.
